(19) United States
(12) Patent Application Publication
(10) Pub. No.: US 2017/0233196 A1
(43) Pub. Date: Aug. 17, 2017

(54) DEVICE FOR SHAPING A NARROW CONTAINER STREAM INTO A WIDE CONTAINER STREAM

(71) Applicant: KHS GmbH, Dortmund (DE)

(72) Inventors: Ulrich Scholz, Lüdinghausen (DE); Sebastian Götze, Dortmund (DE)

(73) Assignee: KHS GmbH, Dortmund (DE)

(21) Appl. No.: 15/503,528

(22) PCT Filed: Jun. 30, 2015
(86) PCT No.: PCT/EP2015/064824

§ 371 Date: Feb. 13, 2017

(30) Foreign Application Priority Data
Aug. 11, 2014 (DE) 10 2014 111 428.0

(51) Int. Cl. B65G 47/71; B65G 15/50

(52) U.S. Cl. CPC B65G 47/715; B65G 15/50

(57) ABSTRACT

An apparatus that shapes a narrow container stream into a wider container stream includes a shaping region in which a deceleration segment follows the container inlet and a shaping segment, which forms the container outlet, follows the deceleration segment. Within the shaping region, laterally adjacent transport bands define a transport plane for moving containers. Container guides extend from the container inlet to the container outlet and delimit corresponding first and second sides of the shaping region between two limit curves. The container guides have inner sides that guide the containers. These sides are curved about axes perpendicular to the horizontal transport plane.

### RELATED APPLICATIONS

This is the national stage under 35 USC 371 of international application PCT/EP2015/064824, tiled on Jun. 30, 2015, which claims the benefit of the Aug. 11, 2014 priority date of DE 102014111428.0, the contents of which are herein incorporated by reference.

### FIELD OF INVENTION

This invention relates to container processing, and in particular, to controlling the width of a container stream.

### BACKGROUND

Run-out tables of container treatment machines shape single-lane container streams at an outlet of a container treatment machine, for example at an outlet of a labeling machine, into a wide container stream. The transport width of the container stream corresponds to a multiple of the diameter of the containers.

To guide containers, such a device typically has at least one oblique ramp or container guide ending on the conveyor by means of which the container stream is shaped into the large transport width. This transport width corresponds to that of the conveyor.

In some cases, transport bands that form a transport plane for the containers are driven by reduction gear arrangements with, in each case, different transport or conveying speeds. Alternatively, or in addition, wedlers are used to achieve improved distribution of the container stream into the width. Preferably, the transport bands that form the containers' transport plane are slat band chains.

Devices along the lines of the foregoing require a substantial structural or transport length and a relatively long transport segment in order to reliably shape a narrow container stream into a wide container stream. In many cases, the desired transport width can only be attained after two sequential stations, or shaping regions. To make matters worse, at high capacity outputs, it is difficult to ensure container stability of the containers, particularly for containers made of plastic or PET (polyethylene terephthalate).

### SUMMARY

An object of the invention is to provide a device for shaping a narrow container stream, and in particular, a single-lane container stream, into a wide container stream, to do so in a way that avoids the disadvantages referred to heretofore, and to do so with a high operational stability.

An advantage of the device described herein is that the shaping of the narrow container stream, into a wide container stream can be achieved on a transport segment that is shorter than those commonly found. The length of the transport segment that is required to shape a narrow container stream into a wide container stream, and which includes the deceleration segment as well as the shaping segment, is in some cases as little as half that of known devices. In some embodiments, this length is on the order of only 1.5 meters.

To achieve this advantage, projections of two container guides of a shaping region onto the transport plane of the containers lie in a region between two limit curves. In addition, one container guide of the shaping region, which is located on the interior relative to the change that the transport direction of the containers undergoes on a deceleration segment, has a convex curve at least along a length that follows the container inlet of the shaping region on its inner side, which is the side guiding the containers, about at least one axis perpendicular to the transport plane. In addition, an opposing container guide of the shaping region has a convex curve along a length thereof following the container inlet of the shaping region, on its inner side guiding the containers, about at least one axis perpendicular to the transport plane.

The container outlet of the shaping region is offset relative to the container inlet of the shaping region in an axial direction that is parallel to the transport plane as well as perpendicular to the shaping or conveying direction of the transport bands that form the transport plane. In addition, the transport hands that form the shaping segment are driven by reduction gear arrangements with different conveying speeds. These speeds are selected such that, with increasing interval spacing of the transport hands in the axial direction from the container inlet, the conveying speed also decreases.

The transport hands that form the transport plane, their bearing mounts and drive units, and the container guides, which are typically guide rails, are provided on a substructure of a machine frame. In some embodiments, the machine frame is about 711 mm wide. This width is derived from three transport bands connecting laterally to one another that form the container inlet, as well as, in particular, the deceleration segment, from an additional transport hand laterally from the container inlet, as well as from a further four laterally connecting transport bands, that are preferably driven by reduction gear arrangements and that form the shaping segment. Each transport band has a width of about 85 mm. The remaining width of the machine frame, namely that portion of the width that is not occupied by the transport hands, accommodates a carrier frame, in particular also for the container guides and a side wall. It is understood, however, that the number of transport bands, and therefore also the width of the device and its machine frame, can deviate from this.

In some embodiments the transport hands are transport chains. Among these are embodiments in which they are slat band chains.

As used herein, “conveying width” is the width of the container stream along an axial direction parallel to the transport plane on which the containers stand with their bases, and perpendicular to the respective conveying direction, or the width that it can occupy due to the course of the lateral container guides.

As used herein, a “container” refers to a can or bottle, whether made of metal, glass, and/or plastic, as well as other packaging means that are suitable, for example, for filling liquid or viscous products.

The expressions “essentially” or “approximately” signify deviations from an exact value by ±10%, preferably by ±5%, and/or deviations in the form of changes that are not of significance to function.

Further embodiments, advantages, and possible applications of the invention are also derived from the following description of exemplary embodiments and from the figures. In this situation, all the features described and/or pictorially represented are in principle the object of the invention, individually or in any desired combination, regardless of their inclusion in the claims or reference made to them. The contents of the claims are also a constituent part of the description.

### BRIEF DESCRIPTION OF THE DRAWINGS

These and other features of the invention will be apparent from the detailed description and the accompanying figures, in which:

FIG. 1 shows an embodiment of a device for shaping a conveyed narrow container stream into a wide container stream to be transported onwards, with a course ideal for this shaping of an outer and an inner container guide of the shaping region;

FIG. 2 shows a representation similar to FIG. 1 with two limit curves for the outer and inner container guide; and

FIG. 3 Shows a port of a profile used for forming container guides.

### DETAILED DESCRIPTION

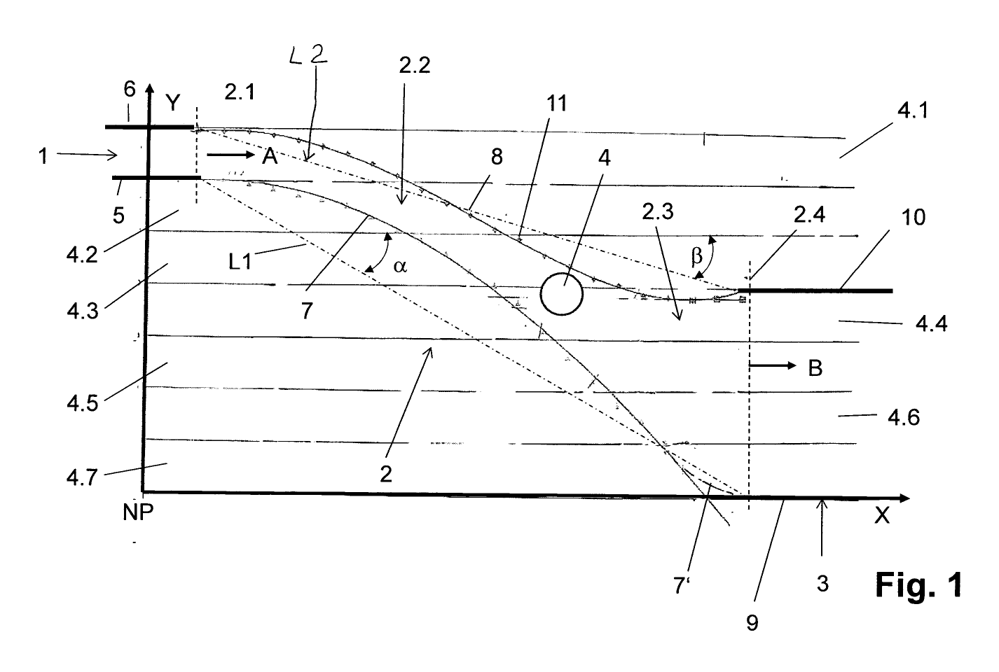

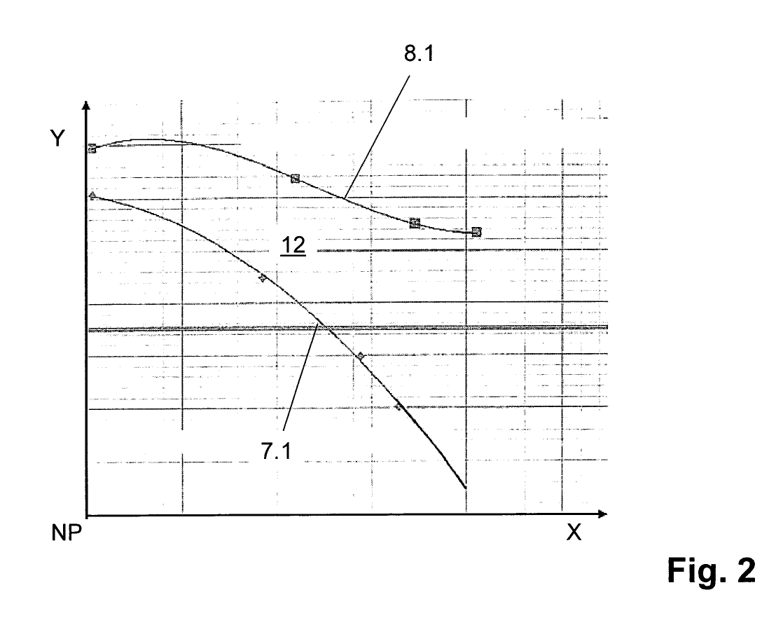

For ease of exposition, FIGS. 1 and 2 show a Cartesian coordinate system overlaid on the apparatus to be described. The point NP is the origin of the coordinate system.

Referring to FIG. 1, a device for shaping the single-lane container stream into a wide multi-lane container stream includes a feed conveyor 1 that feeds along a first transport direction A. A shaping, region 2 follows the teed conveyor 1 along the first transport direction A.

The shaping region 2 extends to a discharge conveyor 3 through which a wide conveyor stream is transported away in a second transport direction B. The discharge conveyor is offset relative to the feed conveyor 1 in the direction of the Y-axis. In a typical embodiment, the wide conveyor stream has a width equal to a multiple of the diameter of the containers 4.

The first and second transport directions A, B are oriented parallel to the X-axis. The X and Y axis together define a horizontal, or essentially horizontal, transport plane, or surface, on which the containers 4 are moved, standing upright on their bases, from the feed conveyor 1, via the shaping region 2, to the discharge conveyor 3.

Between the feed conveyor 1 and the discharge conveyor 3, the shaping region 2 includes a container inlet 2.1, a deceleration segment 2.2, and a shaping segment 2.3 in that order.

The container inlet 2.1 connects directly to the feed conveyor 1. The deceleration segment 2.2 along which, during normal operation, the containers 4 decelerate and change then transport direction in such a way as to reliably form a single-lane container stream in which containers follow one another or directly touch one another, follows the container inlet 2.1. The shaping segment 2.3, along which the wide container stream is formed, follows the deceleration segment 2.2 and ends in a container outlet 2.4. The discharge conveyor 3 follows the container outlet 2.4.

At least within the shaping region 2, first through seventh transport bands 4.1-4.7 form the transport plane. Examples of transport bands 4.1-4.7 include slat band chains. The transport bands 4.1-4.7 extend along the X-axis and are displaced laterally relative to each other along the Y-axis, with a seventh transport band 4.7 being closest to the X-axis, a first transport band 4.1 being furthest from the X-axis, and with transport band 4.n being adjacent to transport band 4.(n+1.) n-1 to 6. The seventh transport band 4.7 is thus furthest from the container inlet 2.1.

The transport bands 4.1-4.7 form a closed loop and can be driven to endlessly circulate by drive units. Upper horizontal lengths of these transport hands 4.1-4.7 thus form the surface of the transport plane that transports along a transport direction parallel to the X-axis.

The first and second transport hands 4.1, 4.2, together with part of the third transport hand 4.3, form the transport plane of the deceleration segment 2.2, which runs increasingly obliquely to the transport direction A. The fourth through seventh transport hands 4.4-4.7, together with part of the third transport band 4.3, form the transport plane of the shaping segment 2.3. The fourth through seventh transport bands 4.4- 4.7 are also the transport bands or at least part of the length of the discharge conveyor 3. As such, they extend in the transport direction B outwards over the container outlet 2.4.

Each transport band 4.n has a conveying speed vₙ. For the shaping of the narrow container stream into the multi-lane or wide container stream, the first, second, and third transport bands 4.1, 4.2, 4.3 are all driven at a first conveying speed v₁=v₂=v₃. The conveying speeds v₄-v₇ of the fourth through seventh transport bands 4.4, 4.5, 4.6, 4.7 are, by contrast, different from the first conveying speed v₁. They are also different from one another.

In particular, the conveying speed v₄ of the fourth transport band 4.4 is lower by a reduction unit or by a factor 14 than the conveying speed v₁. Conveying speeds v₅-v₇ decrease by a factor in each case, with the rising value of their indices, i.e. the conveying speed v₅ of the fifth transport hand 4.5 is lower by a factor i₅ than the conveying speed v₄ the conveying speed v₆ of the sixth transport band 4.6 is lower by a factor i₇ than the conveying speed v₅, and the conveying speed v₇ of the seventh transport band 4.7 is lower by a factor i₇ than the conveying speed v7. The following table summarizes the speeds in a particular embodiment:

| Transport band | Conveying speed | Factor or reduction ratio |
|---|---|---|
| 4.4 | v₄ = v₁ · i₄ | i₄ = 0.7-0.9 |
| 4.5 | v₅ = v₁ · i₅ | i₅ = 0.7-0.9 |
| 4.6 | v₆ = v₁ · i₆ | i₆ = 0.8-0.95 |
| 4.7 | v₇ = v₁ · i₇ | i₇ = 0.6-0.8 |

The different conveying speeds v₁ and v₄-v₇ are attained, for example, by making use of a common drive with corresponding reduction arrangements.

In another embodiment, the speeds are as follows:

| Transport band | Conveying speed | Factor or reduction ratio |
|---|---|---|
| 4.4 | v₄ = v₁ | |
| 4.5 | v₅ = v₄ · i₅ | i₅ = 0.7-0.9 |
| 4.6 | v₆ = v₅ · i₆ | i₆ = 0.8-0.95 |
| 4.7 | v₇ = v₆ · i₇ | i₇ = 0.6-0.8 |

First and second container guides 5, 6 laterally delimit the feed conveyor 1 and determine its lane width. The first container guide 5 leads into a third container guide 7 and the second container guide 6 leads into a fourth container guide 8, both of which are part of the shaping region 2. The inner sides of the third and fourth container guides 7, 8 guide the containers 4 and laterally delimit the transport segment of the shaping region 2.

A fifth container guide 9, which is part of the discharge conveyor 3, connects to the third container guide 7. As shown in FIG. 1, the fifth container guide 9 is coincident with a part of the X-axis. A sixth container guide 10, which is also part of the discharge conveyor 3, connects to the fourth container guide 8. The sixth container guide 10 extends parallel to the X-axis at a distance, from the X-axis. This distance y is equal to the conveyor width of the shaped container stream and the discharge conveyor 3.

In the illustrated embodiment, the first and second container guides 5, 6 and the fifth and sixth container guides 9, 10 extend parallel to or essentially parallel to the X-axis.

In a particular embodiment, all of the foregoing container guides 5, 6, 7, 8, 9, 10 are implemented as guide rails.

As FIG. 1 further shows, the third and fourth container guides 7, 8 run obliquely relative to the X-axis in such a way that: (1) a first imaginary connection line L1, which extends between the start of the third container guide 7 at the container inlet 2.1 and the end of the third container guide 7 at the container outlet 2.4, makes an angle α of 25°-30° with the X-axis; and (2) a second imaginary connection line L2, which extends between the start of the fourth container guide 8 at the container inlet 2.4 and the end of the fourth container guide 8 at the container outlet 2.4, forms an angle β of 13°-15° relative to the X axis. In a preferred embodiment, the angle α is about 30° and the angle β is about 15°.

The third and fourth container guides 7, 8 are not straight lines. They are curved and/or slewed. As shown in FIG. 1, the third container guide 7 is curved to form a convex surface on its inner side, which is the side it uses to guide containers 4. This inner side faces away from the first imaginary connection line L1. The fourth container guide 8 has an S-shaped curve along its inner side, which is the side it uses to guide containers 4.

The first and second imaginary connection lines L1, L2 are useful in visualizing what “concave” and “convex” mean. The “convex” curve is one that tends to first narrow the path up to a point, after which it widens the path. Thus, a convex curve along the third container guide 7 will move away from the first imaginary connection line L1 in a direction towards the second imaginary connection line L2 before it turns around and begins to return toward the first imaginary connection line L1. Conversely, a convex curve along the fourth container guide 8 will move away from the second imaginary connection line L2 toward the first imaginary connection line L1 before finally turning around and returning toward the second imaginary connection line L2. The “concave” curves behave in the converse way.

As shown in FIG. 1, as one traverses the third container guide 7 away from the Y-axis, the third container guide 7 grows further from the first imaginary connection line L1. Eventually, it reaches a maximum distance from the first imaginary connection line L1. As one continues to traverse the third container guide 7, it starts to approach the first imaginary connection line L1 until it once again meets the first imaginary connection line L1 at the container outlet 2.4.

Meanwhile, as one traverses the fourth container guide 8 away from the Y-axis, the fourth container guide 8 grows further from both the first imaginary connection line L1 and the second imaginary connection line L2. Eventually, the fourth container guide 8 reaches a maximum distance from the second imaginary connection line L2. As one continues to traverse the fourth container guide 8, it starts to approach the second imaginary connection line L2 until it crosses it. This crossing point marks the end of a first section and the beginning of a section of the fourth container guide 8.

As one continues, the fourth container guide 8 moves closer to the first imaginary connect line L1 and further from the second imaginary connection line L2. Eventually, it again reaches a maximum distance from the second imaginary connection line L2. As one continues to traverse the fourth container guide 8 past this point, it starts to approach the second imaginary connection line L2 once again, finally meeting it at the container outlet 2.4.

Over the course of the third and fourth container guides 7, 8, the width of the conveying segment increases from the width corresponding to the single-lane container stream to the width of the wide container stream. For example, in the case of a container diameter of 80 mm, the conveying width starts at about 90 mm and continuously increases to about 330-400 mm, which is enough to fit four such containers abreast. By the time one has reached the deceleration segment 2.2 at the transition to the shaping segment, the conveying width will already have reached 135 mm.

Over the course of the third and fourth container guides 7, 8, in the interaction with the different conveying speeds of the transport hands the initially narrow single-lane container stream can be shaped without any interruptions into wide container stream, the conveying width of which corresponds to a multiple of the diameter of the containers 4.

FIG. 1 shows an ideal course for the third and fourth container guides 7, 8. The following equation gives the shape of the projection of the third container guide 7 onto the transport plane:

y=1E-07·x³−0.008·x²+0.1975·x+k₁.

For the course of the fourth container guide 8, i.e. for the course of the projection of the fourth container guide 8 onto the transport plane, the following applies:

y=3E-10·x⁴+1E-08·x³−0.009·x²+0.2633·x+k₂.

In the above equations, x is the distance from the Y-axis, y is the distance from the X-axis, “E” indicates base- 10 exponentiation, and k₁ and k₂ are constants that take into account the diameter D of the containers 4. These constants are related to each other as follows:

k₂=k₁+α₁·D,

where a₁ is a factor between 1.03 and 1.0. Examples of values of k₁ and k₂ are:

k₁=587.68 and k₂=675.42

In the illustrated embodiment, the intersection of the third container guide 7 with the container inlet 2.1 is at (90, 600), the intersection of the third container guide 7 with the container outlet is at (1140, 0), the intersection of the fourth container guide 8 with the container inlet 2.1 is at (90, 700), and the intersection of the container guide 8 with the container outlet 2.4 is at (1140, 380) where (x, y) represent coordinates in the illustrated x-y plane in length units, with a length unit being in the range from 0.8 mm to 1.0 mm.

In an alternative embodiment, the third container guide 7 passes into the fifth container guide 9 via a curved section 7′. The curved section 7′ is a short section having a concave inner side.

FIG. 1 shows the ideal course of the third and fourth container guides 7, 8 in the shaping region 2. The actual course of the third and fourth container guides 7, 8 can deviate from this, for example by ±5%.

For interruption-free operation of the device, however, it is in preferable for the path followed by the third and fourth container guides 7, 8 to lie within a permissible range 12 that is defined by first and second limit curves 7.1, 8.1, as shown in FIG. 2.

The path followed by the first limit curve 7.1, i.e. projection of the limit curve 7.1 onto the transport plane, is given by:

y=−0.0007·x²−0.1582·x+k₃

The path followed by the second limit curve 8.1, i.e. the projection of the limit curve 8.1 onto the transport' plane, is given by:

y=1E-0.6·x³−0.001.5·x²−0.3439·x+k₄

Once again, x is the distance from the Y-axis, y is the distance from the X-axis, “E” corresponds to an exponent, and k₅ and k₄ are constants, with k₃ being related to k₁ by:

k₃=α²·k₁

where a₂, is a factor between 1.02 and 1.04, which preferably amounts to 1.033, and with k₄ being related to k₁ by:

k₄=α₃·k₁,

where a₃ is a factor between 1.18 and 1.2, which preferably amounts to 1.177.

In one example, k₃=607 and k₄=692 so that k₃/k₄=0.88.

The permissible range 12 lying between the first and second limit curves 7.1, 8.1 is a region in which the third and fourth container guides 7, 8 must extend between the container inlet 2.1 and the container outlet 2.4 to attain the interference-free shaping of the container stream.

It has been shown that only if the first and second limit curves 7.1, 8.1 are maintained is it possible to cause interference-free shaping of the single-lane container stream into the multi-lane container stream, in particular into a multi-lane container stream of which the conveying width corresponds to at least four times the conveying width or lane width of the single-lane container stream,

If the foregoing requirements are met, it is not necessary that the third container guide 7 of the shaping region 2, which lies inside relative to the change that the transport direction of the conveyors 4 undergoes on the deceleration segment 2.2, have, along a length following the container inlet 2.1, a convex curve on its inner side, which guides the containers 4, about at least one axis perpendicular to the transport plane.

In addition, if the foregoing requirements are met, it is also not necessary that the opposing fourth container guide 8 of the shaping region 2 have a concave curve following the container inlet 2.1 on its inner side, which guides the containers 4, about at least one axis perpendicular to the transport plane.

In some embodiments, the third and fourth container guides 7, 8 are implemented by providing securing points 11 along the desired path. Among these embodiments are those in which a continuous guide element is secured. This guide element extends all the way from the container inlet 2.1 as far as the container outlet 2.4. Alternatively, individual guide elements are secured to these securing points 11. Each individual guide element in this case extends along the gap between adjacent securing points 11. This results in a piecewise continuous third and fourth container guides.

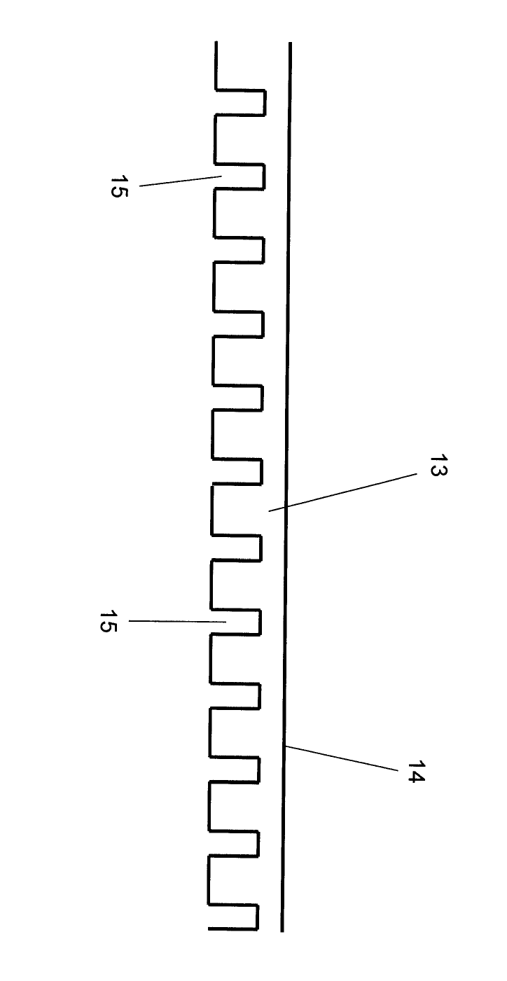

In some embodiments, the third and fourth container guides 7, 8 are in each case realized by a guide profile 13, such as a plastic guide profile, as shown in FIG. 3. The guide profile 13 extends from the container inlet 2.1 to the container outlet 2.4. The inner side 14 of the profile 13, which guides the containers 4, is smooth. The outer side of the guide profile 13 features groove-type incisions 15 that allow the guide profile 13 to follow the desired curvature of the respective third or fourth container guide 7, 8.

In the embodiment described thus far and shown in FIG. 1, the container outlet 2.4 of the shaping region 2 is offset opposite the container inlet 2.1 of the shaping region laterally to the right relative to the transport direction A. An alternative embodiment is a mirror image of the representation in FIG. 1 relative to a plane that is oriented parallel to the X-axis and perpendicular to the transport plane.

The invention has been described heretofore by way of exemplary embodiments. It is understood that modifications and derivations are possible, without thereby departing from the inventive concept underlying the invention.

Having described the invention, and a preferred embodiment thereof, what is claimed as new, and secured by letters patent is:

1-13. (canceled)

14. An apparatus that receives a narrow container stream and shapes said narrow container stream into a wider container stream, said apparatus comprising a shaping region, wherein said shaping region comprises a container inlet, a shaping segment, a deceleration segment, a container outlet, transport bands, a first container guide, and a second container guide, wherein, along a transport direction, said deceleration segment follows said container inlet, and said shaping segment, which forms said container outlet, follows said deceleration segment, wherein, at least within said shaping region, said transport bands, being laterally adjacent to each other, define a horizontal transport plane for carrying containers as said transport bands are driven to circulate endlessly, wherein said first and second container guides extend from said container inlet to said container outlet and delimit corresponding first and second sides of said shaping region, wherein said container guides extend in a region that lies between first and second limit curves, wherein, relative to a coordinate system having an x-axis extending in a transport direction along said horizontal transport plane, a y-axis perpendicular to said x-axis, and a coordinate origin at an intersection of said x-axis and said y-axis, said first limit curve is defined by y=−0.0007·x²−0.1582·x+k₃ and said second limit curve is defined by y=1E-0.6·x³−0.0015·x²−0.3439·x+k₄ wherein x and y are coordinates in said coordinate system, wherein k₃ and k₄ satisfying the relationship k₃/k₄=0.88, and wherein said first and second container guides comprise corresponding first and second inner sides that guide said containers, said first and second inner sides being curved about axes perpendicular to said horizontal transport plane.

15. The apparatus of claim 14, wherein said container inlet and said container outlet define first and second connection lines that extend between said container inlet and said container outlet, wherein said first container guide has ends that lie on said first connection line, wherein said second container guide has ends that lie on said second connection line, wherein said first connection line and said transport direction define a first angle, wherein said second connection line and said transport direction define a second angle that is smaller than said first angle, wherein said first angle lies in the range between 25° and 30°, and wherein said second angle (β) lies in the range between 13° and 15°.

16. The apparatus of claim 14, wherein said first inner side has a convex curve about an axis perpendicular to said horizontal transport plane.

17. The apparatus of claim 14, wherein said first inner side comprises a first length and a second length, wherein said first length extends from said deceleration segment to a point of inflection, wherein said second length extends from said point of inflection to said container outlet, wherein said first length has a convex curve, and wherein said second length has a concave curve.

18. The apparatus of claim 14, wherein along a length thereof that follows said container inlet, said second inner side has a concave curve.

19. The apparatus of claim 14, wherein said second inner guide has a first section that extends from said container inlet to a point of inflection and a second section that extends from said point of inflection to said container outlet, wherein said second section has a convex curve.

20. The apparatus of claim 14, wherein said second inner side has an S-shaped curve having a concave portion and a convex portion, wherein said concave portion follows said container inlet and said convex portion follows said concave portion.

21. The apparatus of claim 14, wherein said first container guide is defined by the equation: y=1E-07·x³−0.008·x²+0.1975·x+k₁, wherein k₁ is a constant that depends on container diameter, and wherein said first container guide deviates from said equation by no more than 5%.

22. The apparatus of claim 14, wherein said second container guide is defined by the equation: y=3E-10·x⁴+1E-08·x³−0.009·x²+0.2633·x+k₂, wherein k₂ is a constant that depends on container diameter, and wherein said second container guide deviates from said equation by no more than 5%.

23. The apparatus of claim 14, wherein said first container guide is defined by the equation: y=1E-07·x³−0.008·x²+0.1975·x+k₁, wherein said second container guide is defined by the equation: y=3E-10·x⁴+1E-08·x³−0.009·x²+0.2633·x+k₂, and wherein k₁ and k₂ are constants that depend on container diameter, and wherein neither said first container guide nor said second container guide deviate from their respective defining equations by no more than 5%.

24. The apparatus of claim 14, wherein said horizontal transport plane is formed from at least seven laterally connecting transport bands, and wherein four of said seven bands form said shaping segment.

25. The apparatus of claim 14, wherein said transport bands comprise a set of transport bands that form said shaping segment, wherein each transport bands in said set is driven at a corresponding conveying speed, wherein a transport band that is further from said second container guide has a lower conveying speed than a transport band that is closer to said second container guide.

26. The apparatus of claim 14, wherein said transport bands comprise a set of transport bands that form said shaping segment, wherein each transport bands in said set is driven at a corresponding conveying speed, wherein a transport band that is further from said second container guide has a lower conveying speed than a transport band that is closer to said second container guide, wherein conveying speeds of adjacent transport bands differ from a conveying speed of a first transport band at said container inlet by a factor that lies between 0.7 and 0.95.

27. The apparatus of claim 14, wherein said transport bands comprise a set of transport bands that form said shaping segment, wherein each transport bands in said set is driven at a corresponding conveying speed, wherein a transport band that is further from said second container guide has a lower conveying speed than a transport band that is closer to said second container guide, wherein said transport bands comprise first, second, third, and fourth transport bands that connect laterally such that said second transport band is between said first and third transport bands and said third transport band is between said second and fourth transport bands, wherein said first, second, third, and fourth transport bands define said horizontal transport plane at said container outlet, wherein a transport band at said container inlet has a first conveying speed, wherein said fourth transport band has a conveying speed that is smaller than said first conveying speed by a factor of between 0.6 and 0.8, wherein said third transport band has a conveying speed that is smaller than said first conveying speed by a factor of between 0.8 and 0.95, wherein said second transport band has a conveying speed that is smaller than said first conveying speed by a factor of between 0.7 and 0.9, and wherein said first transport band has a conveying speed that is smaller than said first conveying speed by a factor of between 0.7 and 0.9.

28. The apparatus of claim 14, further comprising securing points that are arranged along a path, wherein at least one of said first and second container guides, which extends continuously from said container inlet to said container outlet, is secured to said securing points.

29. The apparatus of claim 14, further comprising securing points that are arranged along a path, wherein at least one of said first and second container guides comprises a plurality of guide sections, wherein each guide section is secured to one of said securing points such that said guide sections collectively define said at lease one of said first and second container guides.

30. The apparatus of claim 14, further comprising a guide profile that forms at least one of said first and second container guides, said guide profile having an inner side and an outer side, wherein said inner side guides said containers, wherein said inner side is continuous and smooth, and wherein said outer side comprises groove-shaped notches.

31. The apparatus of claim 14, wherein k₃=607 and k₄=692.

32. The apparatus of claim 14, wherein first, second, third, and fourth transport bands that connect laterally such that said second transport band is between said first and third transport bands and said third transport band is between said second and fourth transport bands form said shaping segment, wherein said first transport band has a first conveying speed, said second transport band has a has a conveying speed that is smaller than said first conveying speed by a factor of between 0.7 and 0.9, said third transport band has a has a conveying speed that is smaller than said second conveying speed by a factor of between 0.95 and 0.8, and said fourth transport band has a has a conveying speed that is smaller than said third conveying speed by a factor of between 0.6 and 0.8.
